(19) United States
(12) Patent Application Publication
(10) Pub. No.: US 2024/0084166 A1
(43) Pub. Date: Mar. 14, 2024

(54) OMNIPHOBIC COMPOSITION CONCENTRATES, RELATED ARTICLES, AND RELATED METHODS

(71) Applicant: BOARD OF TRUSTEES OF MICHIGAN STATE UNIVERSITY, East Lansing, MI (US)

(72) Inventors: Muhammad Rabnawaz, East Lansing, MI (US); Ajmir Khan, East Lansing, MI (US)

(21) Appl. No.: 18/367,079

(22) Filed: Sep. 12, 2023

Related U.S. Application Data
(60) Provisional application No. 63/405,569, filed on Sep. 12, 2022.

(51) Int. Cl. C09D 175/04; C09D 5/00

(52) U.S. Cl. CPC C09D 175/04; C09D 5/00

(57) ABSTRACT

The disclosure relates to an omniphobic composition concentrate including 2 wt. % to 60 wt. % of at least one of a polyisocyanate and monomer units thereof in polymerized form, 30 wt. % to 85 wt. % of at least one of a polyol and monomer units thereof in polymerized form, 10 wt. % to 50 wt. % of at least one of a functionalized omniphobic polymer and monomer units thereof in polymerized form, and up to 60 wt. % of at least one diluent. The omniphobic composition further includes a polymer with monomer units of the polyisocyanate, monomer units of the polyol, and monomer units of the functionalized omniphobic polymer. The omniphobic composition is in the form of a gel-free liquid, and it can be cured with a polyol/polyisocyanate polyurethane base formulation to form a thermoset omniphobic composition.

### CROSS REFERENCE TO RELATED APPLICATION

Priority is claimed to U.S. Provisional Application No. 63/405,569 (filed Sep. 12, 2022), which is incorporated herein by reference in its entirety.

### STATEMENT OF GOVERNMENT INTEREST

None.

### BACKGROUND OF THE DISCLOSURE

### Field of the Disclosure

The disclosure relates to an omniphobic composition concentrate including (i) at least one of a polyisocyanate and monomer units thereof in polymerized form, (ii) at least one of a polyol and monomer units thereof in polymerized form, and (iii) at least one of a functionalized omniphobic polymer and monomer units thereof in polymerized form. The omniphobic composition further includes a polymer with monomer units of the polyisocyanate, polyol, and functionalized omniphobic polymer. The omniphobic composition is in the form of a gel-free liquid that can be cured with a polyol/polyisocyanate polyurethane base formulation to form an omniphobic composition.

### Brief Description of Related Technology

When water accumulates on a surface, the surface energy of the material is directly related to how the water will react. Some surfaces may allow the water to spread out into a pool with a large surface area, whereas others may make water bead up into droplets. The contact angle between the water droplet and the surface is used to characterize the surface into three categories: hydrophilic)(<90°, hydrophobic)(90°-150°, and superhydrophobic)(>150°. FIG. 1 is a visual representation of a contact angle measurement.

Hydrophobicity can be achieved in two ways: controlling the chemical interactions between water and the material surface or altering the surface of the material. Generally, non-polar molecular groups are responsible water beading on a surface as opposed to spreading, due to the lower surface energies exhibited by non-polar groups. A lower surface energy of the material will directly relate to a high contact angle. In contrast, high-energy materials will cause water to spread out in a thin pool, as the polar groups present in surfaces with high energies attract the polar water molecules.

Physically altering the surface (e.g., increasing the roughness thereof) of the material may also increase the hydrophobicity of a material. By creating pillars or other similar features on a textured surface, water interacts with an increased surface area on the material, thus amplifying the chemical interactions between water and the surface. An image depicting how texturing the surface leads to increased contact angle can be seen below in FIG. 2.

A material that repels oils is known as oleophobic or lipophobic depending on if the repelling action is a physical or chemical property, respectively, and operates analogously to hydrophobic materials. These materials are often used on touch screen displays so that bodily oils and sweat gland secretions do not build up on the surface of a screen. A material that exhibits both hydrophobic and oleophobic properties is known as omniphobic. Such materials with very high contact angles are often regarded as “self-cleaning” materials, as contaminants will typically bead up and roll off the surface. As such, these materials have possible applications in screen display, window, and building material coatings.

Hu et al. U.S. Publication No. 2016/0200937 discloses polyurethane-based and epoxy-based compositions that be used as coatings and adhesives with abrasion-resistant, ink-resistant, anti-graffiti, anti-fingerprint properties. The disclosed process for making the compositions requires graft and block copolymer components along with a two-step/two-pot manufacturing process, increasing the time to manufacture and cost of the product.

Rabnawaz et al. U.S. Publication No. 2020/0347179 discloses a thermoset omniphobic composition which includes a thermoset polymer with first, second, and third backbone segments, urethane groups linking the first and third backbone segments, and urea groups linking the first and second backbone segments. The first, second, and third backbone segments generally correspond to urethane or urea reaction products of polyisocyanate(s), amine-functional hydrophobic polymer(s), and polyol(s), respectively.

Rabnawaz U.S. Publication No. 2020/0048459 discloses a thermoset omniphobic composition which includes a thermoset polymer with first, second, and third backbone segments. The first, second, and third backbone segments can correspond to urethane or urea reaction products of polyisocyanate(s), amine-functional omniphobic polymer(s), and polyol(s), respectively, for omniphobic polyurethanes. Similarly, the first, second, and third backbone segments can correspond to urea or beta-hydroxy amine reaction products of polyamine(s), isocyanate-functional omniphobic polymer(s), and polyepoxide(s), respectively, for omniphobic epoxies.

### SUMMARY

In one aspect, the disclosure relates to an omniphobic composition concentrate comprising: 2 wt. % to 60 wt. % relative to the omniphobic composition concentrate of at least one of a polyisocyanate and monomer units thereof in polymerized form; 30 wt. % to 85 wt. % relative to the omniphobic composition concentrate of at least one of a polyol and monomer units thereof in polymerized form; 10 wt. % to 50 wt. % relative to the omniphobic composition concentrate of at least one of a functionalized omniphobic polymer and monomer units thereof in polymerized form; and optionally up to 60 wt. % relative to the omniphobic composition concentrate of at least one diluent (e.g., diluent or solvent liquid medium that is non-reactive with the monomer components and serves as a solvent for the monomers and corresponding non-gel/non-crosslinked polymers thereof in the concentrate). Further, the omniphobic composition can comprise the polyol (e.g., at least some excess, unreacted polyol is present). Additionally, the omniphobic composition can comprise a polymer comprising monomer units of the polyisocyanate, monomer units of the polyol, and monomer units of the functionalized omniphobic polymer. The polymeric component of the omniphobic composition can include a polymer or prepolymer reaction product of the polyisocyanate, polyol, and/or functionalized omniphobic polymer that can be a branched and/or random copolymer, but is not generally crosslinked to an extent that it forms an (insoluble) thermoset or network polymer. The (average) molecular weight of the polymer can be about 10,000 to 50,000 on a number-, weight-, or volume-basis. Yet further, the omniphobic composition can be in the form of a gel-free liquid, for example a liquid solution of the polymer and unreacted monomers without any substantial or measurable solids, such as would result from high molecular weight and/or crosslinked polymers if formed in the concentrate. The omniphobic composition generally forms a clear, non-turbid solution.

In another aspect, the disclosure relates to a method for forming an omniphobic composition concentrate, the method comprising: providing a reaction mixture comprising: 2 wt. % to 60 wt. % relative to the reaction mixture of at least one polyisocyanate; 30 wt. % to 85 wt. % relative to the reaction mixture of at least one polyol; 10 wt. % to 50 wt. % relative to the reaction mixture of at least one functionalized omniphobic polymer; and optionally up to 60 wt. % relative to the reaction mixture of at least one diluent; and partially reacting the at least one polyisocyanate, the at least one polyisocyanate, and the at least one functionalized omniphobic polymer to form a polymer comprising monomer units of the polyisocyanate, monomer units of the polyol, and monomer units of the functionalized omniphobic polymer, thereby forming the omniphobic composition concentrate according to its various refinements, embodiments, etc. The reaction to form the concentrate is partial in the sense that at least some unreacted polyol remains in the concentrate composition, but other individual reactants can be partially, completely, or essentially completely reacted, for example such that they are only present in final concentrate as corresponding monomer units in polymerized form. Suitable reaction times can be from 5 min to 24 hr, but typically about 1-4 hr or 2-3 hr. Suitable reaction temperatures can be from 20-100° C., for example 20-30° C., 30-40° C., or 40-50° C. In embodiments, a ratio of initial isocyanate groups to a combined amount of initial polyol hydroxy groups and initial functionalized omniphobic polymer reactive groups (e.g., hydroxy and/or amino) is in a range of 1:3 to 1:20. The ratio more generally can be at least 1:2.5, 1:3, 1:4, 1:5, or 1:7 and/or up to 1:4, 1:6, 1:8, 1:10, 1:12, 1:15, 1:20, 1:25, or 1:30 (i.e., reflecting an excess of initial hydroxy and/or amino groups in the reaction mixture to form the concentrate compared to initial isocyanate groups).

Various refinements of the disclosed omniphobic composition concentrate and its related method of making are possible.

In a refinement, the omniphobic composition concentrate comprises the at least one diluent in an amount of 2 wt. % to 60 wt. % relative to the omniphobic composition concentrate.

In embodiments, the at least one polyisocyanate and monomer units thereof in polymerized form can be present in the omniphobic composition concentrate in (combined) amounts of at least 2, 3, 4, 5, 7, 10, 15, 20, or 30 wt. % and/or up to 6, 8, 10, 12, 15, 20, 30, 40, 60 wt. %.

In embodiments, the at least one polyol and monomer units thereof in polymerized form can be present in the omniphobic composition concentrate in (combined) amounts of at least 30, 35, 40, 45, 50, 55, or 60 wt. % and/or up to 60, 65, 70, 75, 80, or 85 wt. %.

In embodiments, the at least one functionalized omniphobic polymer and monomer units thereof in polymerized form can be present in the omniphobic composition concentrate in (combined) amounts of at least 10, 12, 15, 20, 25, or 30 wt. % and/or up to 25, 30, 35, 40, 45, or 50 wt. %.

In embodiments, the at least one diluent can be present in the omniphobic composition concentrate in amounts of at least 2, 5, 10, 15, or 20 wt. % and/or up to 20, 25, 30, 35, 40, 50, 55, or 60 wt. %.

As illustrated above, amounts of the omniphobic composition concentrate components can be expressed relative to the concentrate as a whole (i.e., including the reactive monomer components and corresponding polymer components as well as the non-reactive solvent or diluent components). An amount range for a given monomer component and a monomer unit thereof accounts for the total amount of the component, whether as originally added to a reaction mixture to form the concentrate, or whether as present in the concentrate after at least partial reaction to form the polymer component of the concentrate. For example, a concentrate containing 10 wt. % of polyisocyanate and monomer units thereof in polymerized form could contain (i) essentially 1 wt. % of (unreacted) polyisocyanate monomer in solution in the concentrate, and (ii) essentially 9 wt. % of (reacted) polyisocyanate monomer units (e.g., urethane units resulting from reaction with a hydroxy group, urea units resulting from reaction with an amino group) incorporated into the polymer of the concentrate, which distribution could result from initially adding 10 wt. % of polyisocyanate monomer (only) to a reaction mixture with the polyol, functionalized omniphobic polymer, and any optional diluent. This 10/90 distribution between unreacted and reacted components in the concentrate is only illustrative and other distributions are possible for the various polyisocyanate, polyol, and functionalized omniphobic polymer components, including limiting cases where only unreacted monomers are present or only reacted monomer units incorporated into the polymer are present for a given component.

In a refinement, the diluent comprises one or more of a ketone (or mixtures of ketones), an ester (or mixtures of esters), dimethyl formamide, and dimethyl carbonate. More generally, the omniphobic composition concentrate can include a suitable solvent or diluent, for example an aprotic organic solvent such as acetone, tetrahydrofuran, 2-butanone, other ketones (e.g., methyl n-propyl ketone, methyl isobutyl ketone, methyl ethyl ketone, ethyl n-amyl ketone), esters (e.g., C1-C4 alkyl esters of C1-C4 carboxylic acids, such as methyl, ethyl, n-propyl, butyl esters of acetic acid such as n-butyl acetate, etc., n-butyl propionate, ethyl 3-ethoxy propionate), dimethylformamide, dimethyl carbonate, etc. In some cases, a mixture of two or more solvents or diluents can be used for the concentrate. The solvent or diluent is generally non-reactive and evaporated or otherwise removed when the concentrate is used to form a coating or other cured composition.

In a refinement, the at least one of the polyisocyanate and the monomer units thereof in polymerized form are present in an amount of 3 wt. % to 60 wt. % (e.g., at least 3, 4, 5, 7, 10, 15, 20, or 30 wt. % and/or up to 8, 10, 12, 15, 20, 30, 40, 50, or 60 wt. % on a solids basis) relative to a combined amount of the polyisocyanate, the monomer units thereof in polymerized form, the polyol, the monomer units thereof in polymerized form, the functionalized omniphobic polymer, and the monomer units thereof in polymerized form.

In a refinement, the at least one of the polyol and the monomer units thereof in polymerized form are present in an amount of 30 wt. % to 90 wt. % (e.g., at least 30, 35, 40, 45, 50, 55, or 60 wt. % and/or up to 70, 75, 80, 85, or 90 wt. % on a solids basis) relative to a combined amount of the polyisocyanate, the monomer units thereof in polymerized form, the polyol, the monomer units thereof in polymerized form, the functionalized omniphobic polymer, and the monomer units thereof in polymerized form.

In a refinement, the at least one of the functionalized omniphobic polymer and the monomer units thereof in polymerized form are present in an amount of 10 wt. % to 50 wt. % (e.g., at least 10, 15, 20, 25, or 30 wt. % and/or up to 30, 35, 40, 45, or 50 wt. % on a solids basis) relative to a combined amount of the polyisocyanate, the monomer units thereof in polymerized form, the polyol, the monomer units thereof in polymerized form, the functionalized omniphobic polymer, and the monomer units thereof in polymerized form.

As illustrated above, the relative amounts of the monomers and corresponding monomer units incorporated into the polymer can be expressed on a solids basis. This can exclude the amount of solvent, diluent, etc. components that are removed upon eventual formation of a cured coating, and include the amount monomers, monomer units already in polymerized form, and any other solid concentrate components that are incorporated into the final (solid) cured coating.

In a refinement, a ratio of reacted isocyanate groups to a combined amount of free polyol hydroxy groups and free functionalized omniphobic polymer reactive groups (e.g., hydroxy and/or amino) is in a range of 1:2 to 1:20. The reacted isocyanate groups can include one or both of urethane groups resulting from isocyanate/hydroxy reaction and urea groups resulting from isocyanate/amine reaction. The functionalized omniphobic polymer reactive groups can include one or both of hydroxy and amino groups. The ratio more generally can be at least 1:1.5, 1:2, 1:3, 1:4, 1:5, or 1:7 and/or up to 1:4, 1:6, 1:8, 1:10, 1:12, 1:15, 1:20, 1:25, or 1:30 (i.e., reflecting an excess of unreacted hydroxy and/or amino groups in the concentrate compared to essentially completely reacted/consumed isocyanate groups from the original polyisocyanate).

In a refinement, the omniphobic composition concentrate is substantially free from (unreacted) isocyanate groups (e.g., polyisocyanates or corresponding polymer chains with unreacted or free isocyanate groups). The polyisocyanate can be initially added to the omniphobic composition concentrate as a limiting reactant such that essentially all of the original polyisocyanate is present as a monomer unit of the polyisocyanate in the polymer of the concentrate. For example, the concentrate can contain up to (or not more than) 1, 0.1, 0.01, or 0.001 wt. % of the polyisocyanate (e.g., which contains unreacted isocyanate groups).

In a refinement, the omniphobic composition concentrate contains the polyol in an amount of 40 wt. % to 90 wt. % relative to a combined amount of the polyol and the monomer units thereof in polymerized form. The omniphobic composition concentrate is generally formed with an excess of polyol such that the final concentrate can contain at least 40, 50, or 60 wt. % and/or up to 70, 80, or 90 wt. % polyol (i.e., unreacted polyol) relative to a combined amount of the polyol and the monomer units thereof in polymerized form. Similarly, the final concentrate can contain at least 10, 20, or 30 wt. % and/or up to 40, 50, or 60 wt. % reacted/polymerized polyol monomer units relative to a combined amount of the polyol and the monomer units thereof in polymerized form.

In a refinement, the omniphobic composition concentrate contains the functionalized omniphobic polymer in an amount up to 50 wt. % relative to a combined amount of the functionalized omniphobic polymer and the monomer units thereof in polymerized form. The omniphobic composition concentrate is generally formed with a limiting amount or small excess of functionalized omniphobic polymer such that the final concentrate can contain at least 0.1, 1, 2, 5, 10, or 15 wt. % and/or up to 1, 2, 5, 10, 20, 30, or 50 wt. % functionalized omniphobic polymer (i.e., unreacted functionalized omniphobic polymer) relative to relative to a combined amount of the functionalized omniphobic polymer and the monomer units thereof in polymerized form. Similarly, the final concentrate can contain at least 50, 60, 70, 80, 95, 98, or 99 wt. % and/or up to 80, 90, or 100 wt. % reacted/polymerized monomer units of the functionalized omniphobic polymer relative to relative to a combined amount of the polyol and the monomer units thereof in polymerized form.

In a refinement, the omniphobic composition concentrate is storage stable and remains gel-free for periods of 7 days, 14 days, 28 days, 2 months, 3 months, 4 months, 6 months, or longer, for example after initial formation and reaction to form the concentrate. The concentrate can remain a stable solution without substantial further polymerization during storage that would increase molecular weight or cause crosslinking to create solid/gel precipitate, such as at ambient conditions (e.g., at 10-40° C., 20-30° C., or about 25° C.). A gel-free state can be characterized as a substantial absence of solid or semi-solid materials (e.g., not more than 0.001, 0.01, 0.1, or 1 wt. % of such materials in the concentrate as originally formed or after a given storage period). A gel-free state alternatively can be characterized as the ability to dissolve the concentrate completely in an (excess) amount of common organic solvents (e.g., ketones, esters, and those described above for the diluent).

In a refinement, the omniphobic composition concentrate is free from additives and fillers. Typically, any desired additives/fillers would be included in the base formulation to which the concentrate is added, but not generally in the concentrate itself.

In a refinement, the polyisocyanate comprises a diisocyanate and/or a triisocyanate. In various embodiments, the omniphobic composition concentrate can include only diisocyanates (and their corresponding monomer units), only tri- or higher-functional isocyanates (and their corresponding monomer units), or a combination of diisocyanates and tri- or higher-functional isocyanates (and their corresponding monomer units). In some embodiments containing both (i) diisocyanates and (ii) tri- or higher-functional isocyanates, the diisocyanates can be present in an amount of 80-99.5 wt. % (e.g., at least 80, 85, 90, or 95 wt. % and/or up to 96, 98, 99, or 99.5 wt. %) relative to total polyisocanates, and the tri- or higher-functional isocyanates can be present in an amount of 0.5-20 wt. % (e.g., at least 0.5, 1, 2, or 4 wt. % and/or up to 5, 10, 15, or 20 wt. %) relative to total polyisocanates. The relatively larger proportion of diisocyanates in the omniphobic composition concentrate can promote formation of the polymer without excessive branching so as to avoid gelation (e.g., an avoid creation of crosslinks in the polymer).

In a refinement, the polyisocyanate is selected from the group consisting of 1,5-naphthylene diisocyanate, 4,4′-diphenylmethane diisocyanate (MDI), hydrogenated MDI, xylene diisocyanate (XDI), tetramethylxylol diisocyanate (TMXDI), 4,4′-diphenyl-dimethylmethane diisocyanate, di- and tetraalkyl-diphenylmethane diisocyanate, 4,4′-dibenzyl diiso-cyanate, 1,3-phenylene diisocyanate, 1,4-phenylene diisocyanate, one or more isomers of tolylene diisocyanate (TDI), 1-methyl-2,4-diiso-cyanatocyclohexane, 1,6-diisocyanato-2,2,4-trimethyl-hexane, 1,6-diisocyanato-2,4,4-trimethylhexane, 1-iso-cyanatomethyl-3-isocyanato-1,5,5-trimethylcyclohexane, chlorinated and brominated diisocyanates, phosphorus-containing diisocyanates, 4,4′-diisocyanatophenyl-perfluoroethane, tetramethoxybutane 1,4-diisocyanate, butane 1,4-diisocyanate, hexane 1,6-diisocyanate (HDI), HDI dimer (HDID), HDI trimer (HDIT), HDI biuret, dicyclohexylmethane diisocyanate, cyclohexane 1,4-diisocyanate, ethylene diisocyanate, phthalic acid bisisocyanatoethyl ester, 1-chloromethylphenyl 2,4-diisocyanate, 1-bromomethylphenyl 2,6-diisocyanate, 3,3-bischloromethyl ether 4,4′-diphenyldiisocyanate, trimethylhexamethylene diisocyanate, 1,4-diisocyanato-butane, 1,2-diisocyanatododecane, and combinations thereof.

In a refinement, the polyol comprises a diol and/or three or more hydroxyl groups. In embodiments, the polyol is selected from the group consisting of polyether polyols, hydroxylated (meth)acrylate oligomers or copolymers, glycerol, ethylene glycol, diethylene glycol, triethylene glycol, tetraethylene glycol, propylene glycol, dipropylene glycol, tripropylene glycol, 1,3-propanediol, 1,3-butanediol, 1,4-butanediol, neopentyl glycol, 1,6-hexanediol, 1,4-cyclohexanedimethanol, glycerol, trimethylolpropane, 1,2,6-hexanetriol, pentaerythritol, (meth)acrylic polyols, polyester polyols, polyurethane polyols, and combinations thereof.

In a refinement, the functionalized omniphobic polymer comprises a dihydroxy-functional polysiloxane (e.g., di-OH functional PDMS).

In a refinement, the functionalized omniphobic polymer comprises a diamino-functional polysiloxane (e.g., di-NH₂ functional PDMS).

In a refinement, the functional group of the functionalized omniphobic polymer is selected from the group consisting of amino groups, hydroxyl groups, and combinations thereof.

In a refinement, the functionalized omniphobic polymer is selected from the group consisting of functionalized polysiloxanes, functionalized polyperfluoroethers, functionalized polybutadienes, functionalized polyisobutenes, functionalized branched polyolefins, functionalized low molecular weight polyolefins, functionalized poly(meth)acrylates, and combinations thereof.

In a refinement, the functionalized omniphobic polymer comprises a mono-functional functionalized omniphobic polymer.

In a refinement, the functionalized omniphobic polymer comprises a di-functional functionalized omniphobic polymer.

In a refinement, the functionalized omniphobic polymer comprises a poly-functional functionalized omniphobic polymer.

In a refinement, the functionalized omniphobic polymer has a glass transition temperature in a range from −150° C. to 70° C.

In a refinement, the functionalized omniphobic polymer is a liquid at a temperature in a range from 10° C. to 40° C.

In a refinement, the functionalized omniphobic polymer has a molecular weight ranging from 300 to 50,000.

In another aspect, the disclosure relates to a method for forming a (thermoset) omniphobic composition, the method comprising: combining (e.g., mixing together prior to application to a surface or substrate, co-applying to a surface or substrate, etc.) (i) the omniphobic composition concentrate according to any of the variously disclosed embodiments, refinements, etc., and (ii) a polyurethane base formulation comprising at least one further polyisocyanate and at least one further polyol; and curing the omniphobic composition concentrate and the polyurethane base formulation to form a crosslinked reaction product as the (thermoset) omniphobic composition. During curing, the further polyisocyanate and the further polyol can react not only with each other to form a polyurethane structure, but also with the polymer of the concentrate (i.e., which can contain isocyanate, hydroxyl, or other reactive functional groups from the omniphobic polymer) as well as unreacted polyisocyanate, polyol, and/or functionalized omniphobic polymer in the concentrate. The curing step also generally includes evaporation of any solvent or diluent either in the omniphobic composition concentrate or the polyurethane base formulation. The same general polyisocyanate components as described above can be used for the further polyisocyanate. The further polyisocyanate in the polyurethane base formulation can be the same or different as the polyisocyanate used to form the omniphobic composition concentrate. The same general polyol components as described above can be used for the further polyol. The further polyol in the polyurethane base formulation can be the same or different as the polyol used to form the omniphobic composition concentrate.

Various refinements of the disclosed method for forming a (thermoset) omniphobic composition are possible.

In a refinement, the omniphobic composition concentrate is combined with the polyurethane base formulation (e.g., prior to curing) in a relative amount of 1:10 to 1:100 (w/w) for the omniphobic composition concentrate:the polyurethane base formulation (e.g., at least 1:10, 1:15, 1:20, 1:25, or 1:30 and/or up to 1:20, 1:25, 1:30, 1:35, 1:40, 1:50, 1:60, 1:80, or 1:100).

In a refinement, the monomer units of the functionalized omniphobic polymer are present in the (thermoset) omniphobic composition in an amount of 0.2 wt. % to 5 wt. % (e.g., at least 0.2, 0.4, 0.7, 1, 1.2, or 1.5 wt. % and/or up to 1.5, 2, 2.5, 3, 4, or 5 wt. %) relative to the (thermoset) omniphobic composition.

In a refinement, the at least one further polyisocyanate comprises a tri- or higher-functional isocyanate (e.g., to promote crosslinking and thermoset formation).

In a refinement, the at least one further polyisocyanate is present in an amount of 5 wt. % to 40 wt. % (e.g., at least 5, 10, 15, 20, or 25 wt. % and/or up to 20, 25, 30, 35, or 40 wt. %) relative to the polyurethane base formulation (e.g., relative to the combined amount of the further polyisocyanate and the further polyol); and/or the at least one further polyol is present in an amount of 60 wt. % to 95 wt. % (e.g., at least 60, 65, 70, 75, or 80 wt. % and/or up to 75, 80, 85, 90, or 95 wt. %) relative to the polyurethane base formulation (e.g., relative to the combined amount of the further polyisocyanate and the further polyol).

In a refinement, the polyurethane base formulation is free from functionalized omniphobic polymers (e.g., where the omniphobic composition concentrate is essentially the only source of functionalized omniphobic polymer monomer units in the final crosslinked reaction product and thermoset omniphobic composition).

In a refinement, the polyurethane base formulation further comprises one or more additives (or fillers) selected from the group consisting of nanoclay, graphene oxide, graphene, silicon dioxide (silica), aluminum oxide, cellulose nanocrystals, carbon nanotubes, titanium dioxide (titania), diatomaceous earth, biocides, pigments, dyes, thermoplastics, and combinations thereof.

In a refinement, the method comprises performing curing at a temperature in a range of 25° C. to 120° C. or 45° C. to 70° C. and for a time in a range of 1 h to 10 hr or 2 h to 4 hr.

In a refinement, the method further comprises applying the omniphobic composition concentrate and the polyurethane base formulation (e.g., as a mixture) to a substrate; and curing the omniphobic composition concentrate and the polyurethane base formulation on the substrate, thereby forming the (thermoset) omniphobic composition as a coating on the substrate. The substrate can be selected from the group of metal, plastics, a different thermoset material, glass, wood, fabric (or textile), and ceramics.

In a refinement, the (thermoset) omniphobic composition has a water contact angle in a range from 90° to 120°.

In a refinement, the (thermoset) omniphobic composition has an oil contact angle in a range from 1° to 65°.

In a refinement, the (thermoset) omniphobic composition has a water sliding angle in a range from 1° to 30° for a 75 μl droplet.

In a refinement, the (thermoset) omniphobic composition has an oil sliding angle in a range from 1° to 20° for a 10 μl droplet.

In a refinement, the (thermoset) omniphobic composition has a thickness ranging from 0.01 μm to 500 μm.

In a refinement, the (thermoset) omniphobic composition has a clarity of at least 90, 95, 98, or 99% and/or up to 94, 96, 98, 99, or 100% transmission (e.g., light transmission through the omniphobic composition, such as for a cast film).

In another aspect, the disclosure relates to a coated article comprising: (a) a substrate; and (b) a (thermoset) omniphobic composition formed according to any of the variously disclosed methods, coated on a surface of the substrate.

While the disclosed articles, apparatus, and methods are susceptible of embodiments in various forms, specific embodiments of the disclosure are illustrated (and will hereafter be described) with the understanding that the disclosure is intended to be illustrative, and is not intended to limit the claims to the specific embodiments described and illustrated herein.

### BRIEF DESCRIPTION OF THE DRAWINGS

For a more complete understanding of the disclosure, reference should be made to the following detailed description and accompanying drawings wherein:

FIG. 1 is a diagram illustrating measurement of a contact angle for a liquid droplet on a surface.

FIG. 2 is a diagram illustrating how contact angles for a given liquid droplet on a surface can vary as a function of surface topology (e.g., flat or smooth surface vs. textured surfaces).

FIG. 3 illustrates a coated article according to the disclosure in which a thermoset omniphobic composition formed using an omniphobic composition concentrate is coated on a substrate.

### DETAILED DESCRIPTION

The disclosure relates to an omniphobic composition concentrate including 2 wt. % to 60 wt. % of at least one of a polyisocyanate and monomer units thereof in polymerized form, 30 wt. % to 85 wt. % of at least one of a polyol and monomer units thereof in polymerized form, 10 wt. % to 50 wt. % of at least one of a functionalized omniphobic polymer and monomer units thereof in polymerized form, and up to 60 wt. % of at least one diluent. The omniphobic composition further includes a polymer with monomer units of the polyisocyanate, monomer units of the polyol, and monomer units of the functionalized omniphobic polymer. The omniphobic composition is in the form of a gel-free liquid, and it can be cured with a polyol/polyisocyanate polyurethane base formulation to form a thermoset omniphobic composition.

The disclosed composition includes an omniphobic composition concentrate that can be used with a polyurethane base formulation to form a thermoset omniphobic polymer which can be used as a coating with the ability to bind to metal, glass, wood, fabrics, and ceramics with relative ease, in particular due to the strong adhesive properties of its thermoset constituents (e.g., such as for polyurethane thermoset constituents). The omniphobic composition concentrate is generally a stable, clear, and gel-free composition that can be prepared and then stored in its stable, clear, and gel-free state for substantial periods before being combined the polyurethane base formulation. The omniphobic composition concentrate provides several advantages over a typical approach of combining and curing all coating components at one time: (1) The omniphobic composition concentrate is applicable to forming a coating for a wide range of polyurethanes by combining the concentrate with various polyurethane formulations, in particular when the excess polyol in the concentrate matches that of the targeted polyurethane formulations (e.g., polyester-based, polyether-based, polycarbonate-based, acrylic-based, etc. polyurethane formulation with a common polyol relative to the concentrate). (2) The omniphobic composition concentrate also eliminates complicated mixing process for end users. (3) The omniphobic composition concentrate also provides consistent performance in the eventual formed coating. The polymer coating has an omniphobic quality, repelling water, oils, inks, and spray paints, thus allowing for a coating that not only has typical hydrophobic and oleophobic properties, but also protects a surface from pen inks and various paints. The final polymer product is optically clear (even for relatively thick coatings), making it an ideal choice for coating computer and phone screens as well as windows. The polymer can be manufactured without fluorine as a component and/or as a one-pot reaction process, thus reducing the overall cost when compared to products currently manufactured. Coatings formed from the polymer composition are durable due to the final crosslinked thermoset matrix. The composition can be used in water-repellent, oil-repellent, anti-fingerprint, anti-smudge, and/or anti-graffiti coatings or paints.

### Omniphobic Composition Concentrate

An omniphobic composition concentrate according to the disclosure includes a polymer including polymerized monomer units of a polyisocyanate, a polyol, and a functionalized omniphobic polymer. The polymeric component of the omniphobic composition can include a polymer or prepolymer reaction product of the polyisocyanate, polyol, and/or functionalized omniphobic polymer that can be a branched and/or random copolymer, but is not generally crosslinked to an extent that it forms an (insoluble) thermoset or network polymer. The (average) molecular weight of the polymer can be about 10,000 to 50,000 g/mol on a number-, weight-, or volume-basis, for example at least 10,000, 15,000, 20,000, 25,000 or 30,000 and/or up to 30,000, 35,000, 40,000, 45,000 or 50,000 g/mol number-, weight-, or volume-basis. The concentrate further includes at least some of the polyol (e.g., unreacted or free polyol), and it can optionally include one or more of the polyisocyanate (e.g., unreacted or free polyisocyanate), the functionalized omniphobic polymer (e.g., unreacted or free functionalized omniphobic polymer), and a diluent. The omniphobic concentrate can be in the form of a gel-free liquid, for example a liquid solution of the polymer and unreacted monomers without any substantial or measurable solids, such as would result from high molecular weight and/or crosslinked polymers if formed in the concentrate. The omniphobic concentrate generally forms a clear, non-turbid solution.

In embodiments, the omniphobic composition concentrate contains 2 wt. % to 60 wt. % relative to the omniphobic composition concentrate of the polyisocyanate and monomer units thereof in polymerized form, for example in (combined) amounts of at least 2, 3, 4, 5, 7, 10, 15, 20, or 30 wt. % and/or up to 6, 8, 10, 12, 15, 20, 30, 40, 60 wt. %. In some further embodiments, the polyisocyanate and the monomer units thereof in polymerized form can be present in the concentrate in an amount of 3 wt. % to 60 wt. % (e.g., at least 3, 4, 5, 7, 10, 15, 20, or 30 wt. % and/or up to 8, 10, 12, 15, 20, 30, 40, 50, or 60 wt. % on a solids basis) relative to a combined amount of the polyisocyanate, the monomer units thereof in polymerized form, the polyol, the monomer units thereof in polymerized form, the functionalized omniphobic polymer, and the monomer units thereof in polymerized form.

In some embodiments, a ratio of reacted isocyanate groups to a combined amount of free polyol hydroxy groups and free functionalized omniphobic polymer reactive groups (e.g., hydroxy and/or amino) is in a range of 1:2 to 1:20. The reacted isocyanate groups can include one or both of urethane groups resulting from isocyanate/hydroxy reaction and urea groups resulting from isocyanate/amine reaction. The functionalized omniphobic polymer reactive groups can include one or both of hydroxy and amino groups. The ratio more generally can be at least 1:1.5, 1:2, 1:3, 1:4, 1:5, or 1:7 and/or up to 1:4, 1:6, 1:8, 1:10, 1:12, 1:15, 1:20, 1:25, or 1:30, which reflects an excess of unreacted hydroxy and/or amino groups in the concentrate compared to essentially completely reacted/consumed isocyanate groups from the original polyisocyanate.

In some embodiments, the omniphobic composition concentrate is substantially free from (unreacted) isocyanate groups, for example including polyisocyanate monomers or corresponding polymer chains with unreacted or free isocyanate groups. The polyisocyanate can be initially added to the omniphobic composition concentrate as a limiting reactant such that essentially all of the original polyisocyanate is present as a monomer unit of the polyisocyanate in the polymer of the concentrate. For example, the concentrate can contain up to (or not more than) 1, 0.1, 0.01, or 0.001 wt. % of the polyisocyanate (e.g., which contains unreacted isocyanate groups).

In some embodiments, the polyisocyanate can include one or more diisocyanates and/or one or more triisocyanates. In various embodiments, the omniphobic composition concentrate can include only diisocyanates (and their corresponding monomer units), only tri- or higher-functional isocyanates (and their corresponding monomer units), or a combination of diisocyanates and tri- or higher-functional isocyanates (and their corresponding monomer units). In some embodiments containing both (i) diisocyanates and (ii) tri- or higher-functional isocyanates, the diisocyanates can be present in an amount of 80-99.5 wt. % (e.g., at least 80, 85, 90, or 95 wt. % and/or up to 96, 98, 99, or 99.5 wt. %) relative to total polyisocanates, and the tri- or higher-functional isocyanates can be present in an amount of 0.5-20 wt. % (e.g., at least 0.5, 1, 2, or 4 wt. % and/or up to 5, 10, 15, or 20 wt. %) relative to total polyisocanates. The relatively larger proportion of diisocyanates in the omniphobic composition concentrate can promote formation of the polymer without excessive branching so as to avoid gelation (e.g., an avoid creation of crosslinks in the polymer).

The polyisocyanate is not particularly limited and generally can include any aromatic, alicyclic, and/or aliphatic isocyanates having at least two reactive isocyanate groups (—NCO). Suitable polyisocyanates contain on average 2-4 isocyanate groups. In some embodiments, the polyisocyanate includes a diisocyanate. In some embodiments, the polyisocyanate includes triisocyanate. Suitable diisocyanates can have the general structure (O═C═N)—R—(N═C═O), where R can include aromatic, alicyclic, and/or aliphatic groups, for example having at least 2, 4, 6, 8, 10 or 12 and/or up to 8, 12, 16, or 20 carbon atoms. Examples of specific polyisocyanates include 1,5-naphthylene diisocyanate, 4,4′-diphenylmethane diisocyanate (MDI), hydrogenated MDI, xylene diisocyanate (XDI), tetramethylxylol diisocyanate (TMXDI), 4,4′-diphenyl-dimethylmethane diisocyanate, di- and tetraalkyl-diphenylmethane diisocyanate, 4,4′-dibenzyl diisocyanate, 1,3-phenylene diisocyanate, 1,4-phenylene diisocyanate, one or more isomers of tolylene diisocyanate (TDI, such as toluene 2,4-diisocyanate), 1-methyl-2,4-diiso-cyanatocyclohexane, 1,6-diisocyanato-2,2,4-trimethyl-hexane, 1,6-diisocyanato-2,4,4-trimethylhexane, 1-iso-cyanatomethyl-3-isocyanato-1,5,5-trimethylcyclohexane, chlorinated and brominated diisocyanates, phosphorus-containing diisocyanates, 4,4′-diisocyanatophenyl-perfluoroethane, tetramethoxybutane 1,4-diisocyanate, butane 1,4-diisocyanate, hexane 1,6-diisocyanate (or hexamethylene diisocyanate; HDI), HDI dimer (HDID), HDI trimer (HDIT), HDI biuret, 1,5-pentamethylene diisocyanate (PDI), PDID (dimer of PDI), PDIT (trimer of PDI), PDI biuret, dicyclohexylmethane diisocyanate, cyclohexane 1,4-diisocyanate, ethylene diisocyanate, phthalic acid bisisocyanatoethyl ester, 1-chloromethylphenyl 2,4-diisocyanate, 1-bromomethylphenyl 2,6-diisocyanate, 3,3-bischloromethyl ether 4,4′-diphenyldiisocyanate, trimethylhexamethylene diisocyanate, 1,4-diisocyanato-butane, 1,2-diisocyanatododecane, and combinations thereof.

In embodiments, the omniphobic composition concentrate contains 30 wt. % to 85 wt. % relative to the omniphobic composition concentrate of the polyol and monomer units thereof in polymerized form, for example in (combined) amounts of at least 30, 35, 40, 45, 50, 55, or 60 wt. % and/or up to 60, 65, 70, 75, 80, or 85 wt. %. In some further embodiments, the polyol and the monomer units thereof in polymerized form can be present in the concentrate in an amount of 30 wt. % to 90 wt. % (e.g., at least 30, 35, 40, 45, 50, 55, or 60 wt. % and/or up to 70, 75, 80, 85, or 90 wt. % on a solids basis) relative to a combined amount of the polyisocyanate, the monomer units thereof in polymerized form, the polyol, the monomer units thereof in polymerized form, the functionalized omniphobic polymer, and the monomer units thereof in polymerized form.

In some embodiments, the omniphobic composition concentrate contains the polyol in an amount of 40 wt. % to 90 wt. % relative to a combined amount of the polyol and the monomer units thereof in polymerized form. The omniphobic composition concentrate is generally formed with an excess of polyol such that the final concentrate can contain at least 40, 50, or 60 wt. % and/or up to 70, 80, or 90 wt. % polyol (i.e., unreacted polyol) relative to a combined amount of the polyol and the monomer units thereof in polymerized form. Similarly, the final concentrate can contain at least 10, 20, or 30 wt. % and/or up to 40, 50, or 60 wt. % reacted/polymerized polyol monomer units relative to a combined amount of the polyol and the monomer units thereof in polymerized form.

The polyol is not particularly limited and generally can include any aromatic, alicyclic, and/or aliphatic polyols with at least two reactive hydroxyl/alcohol groups (—OH). Suitable polyol monomers contain on average 2-4 hydroxyl groups on aromatic, alicyclic, and/or aliphatic groups, for example having at least 4, 6, 8, 10 or 12 and/or up to 8, 12, 16, or 20 carbon atoms. In some embodiments, the polyol is a diol. In some embodiments, the polyol is a triol. Examples of specific polyols include one or more of polyether polyols (e.g., polypropylene oxide-based triols such as commercially available MULTRANOL 4011 with a MW of about 300), triethanolamine, hydroxylated (meth)acrylate oligomers (e.g., 2-hydroxylethyl methacrylate or 2-hydroxyethyl acrylate), glycerol, ethylene glycol, diethylene glycol, triethylene glycol, tetraethylene glycol, propylene glycol, dipropylene glycol, tripropylene glycol, 1,3-propanediol, 1,3-butanediol, 1,4-butanediol, neopentyl glycol, 1,6-hexanediol, 1,4-cyclohexanedimethanol, trimethylolpropane, 1,2,6-hexanetriol, pentaerythritol, (meth)acrylic polyols (e.g., having random, block, and/or alternating hydroxyl functionalities along with other (meth)acrylic moieties), polyester polyols, polyurethane polyols, and isosorbide. The polyol can be biobased or made of synthetic feedstock.

In embodiments, the omniphobic composition concentrate contains 10 wt. % to 50 wt. % relative to the omniphobic composition concentrate of the functionalized omniphobic polymer and monomer units thereof in polymerized form, for example in (combined) amounts of at least 10, 12, 15, 20, 25, or 30 wt. % and/or up to 25, 30, 35, 40, 45, or 50 wt. %. In some further embodiments, the functionalized omniphobic polymer and the monomer units thereof in polymerized form can be present in the concentrate in an amount of 10 wt. % to 50 wt. % (e.g., at least 10, 15, 20, 25, or 30 wt. % and/or up to 30, 35, 40, 45, or 50 wt. % on a solids basis) relative to a combined amount of the polyisocyanate, the monomer units thereof in polymerized form, the polyol, the monomer units thereof in polymerized form, the functionalized omniphobic polymer, and the monomer units thereof in polymerized form.

In some embodiments, the omniphobic composition concentrate contains the functionalized omniphobic polymer in an amount up to 50 wt. % relative to a combined amount of the functionalized omniphobic polymer and the monomer units thereof in polymerized form. The omniphobic composition concentrate is generally formed with a limiting amount or small excess of functionalized omniphobic polymer such that the final concentrate can contain at least 0.1, 1, 2, 5, 10, or 15 wt. % and/or up to 1, 2, 5, 10, 20, 30, or 50 wt. % functionalized omniphobic polymer (i.e., unreacted functionalized omniphobic polymer) relative to relative to a combined amount of the functionalized omniphobic polymer and the monomer units thereof in polymerized form. Similarly, the final concentrate can contain at least 50, 60, 70, 80, 95, 98, or 99 wt. % and/or up to 80, 90, or 100 wt. % reacted/polymerized monomer units of the functionalized omniphobic polymer relative to relative to a combined amount of the polyol and the monomer units thereof in polymerized form.

The functionalized omniphobic polymer is not particularly limited and generally can include any omniphobic polymer with glass transition temperature of 70° C. or 50° C. or less, such as in a range from −150° C. to 70° C. or 50° C. The functionalized omniphobic polymer is generally a liquid at a temperature of at least 10, 15, or 20° C. and/or up to 20, 25, 30, 35, or 40° C. The functional group of the functionalized omniphobic polymer can include one or more amino groups and/or one or more hydroxyl groups (e.g., including only one type of functional group or both types of functional groups). In various embodiments, the functionalized omniphobic polymer can include one or more of a mono-functional functionalized omniphobic polymer, a di-functional functionalized omniphobic polymer (e.g., a dihydroxy-functional polysiloxane and/or a diamino-functional polysiloxane), and a a poly-functional functionalized omniphobic polymer. Examples of general classes of functionalized omniphobic polymers include functionalized polysiloxanes, functionalized polyperfluoroethers, functionalized polybutadienes, functionalized polyolefins (e.g., polyethylene, polypropylene, polybutylene), and combinations or mixtures thereof. The functionalized polyperfluoroether (e.g., functionalized polyperfluoropolyethers) can include mono-, di-, or higher functionalized polyperfluoroethers, or a blend of thereof, such as a blend of mono- and di-functional polyperfluorothers. The functionalized polybutadiene can include mono-, di-, or higher functional polybutadienes, or a blend of thereof, such as a blend mono- and di-functional polybutadienes. Many suitable functionalized omniphobic polymers are commercially available (e.g., amine-, isocyanate-, or other functional polydimethylsiloxane (PDMS) with a variety of available degrees of functionality and molecular weights). Omniphobic polymers that are not commercially available in their functionalized form can be functionalized using conventional chemical synthesis techniques, for example including but not limited to hydroamination, thiol-ene Michael reaction of amine-carrying thiols, Mitsunobu reaction, and reductive amination.

The functionalized polysiloxane is not particularly limited and generally can include any polysiloxane having mono-, di-, or higher degrees functionality. In some embodiments, the functionalized polysiloxane includes a mono-functional polysiloxane. In some embodiments, the functionalized polysiloxane includes a di-functional polysiloxane. The polysiloxane can be a polydialklylsiloxane having —Si(R₁R₂)—O— repeat units, where R₁ and R₂ independently can be C₁-C₁₂ linear or branched alkyl groups, C₄-C₁₂ cycloalkyl groups, unsubstituted aromatic groups, or substituted aromatic groups, in particular where R₁ and R₂ are methyl groups for a polydimethylsiloxane (PDMS). The functional groups are suitably terminal groups. For example, in an amine-functional polydialklylsiloxane, the structure and terminal groups can be represented by NH₂—R₃—[Si(R₁R₂)—O], —R₃—NH₂ for a diamine or NH₂—R₃— [Si(R₁R₂)—O], —R₃ for a monoamine, where R₃ independently can be H (when a terminal group) or C₁-C₁₂ linear or branched alkyl (when a terminal group or a linker for a terminal amine). The functional groups additionally can be pendant groups, for example in a amine-functional polydialklylsiloxane represented by R₃—[Si(R₁R₂)—O], —[Si(R₁R₂)—O]ₓ—R₃, where R₁, and R₂, independently can be the same as R₁ and R₂, but at least one or both of R₁, and R_{2′} independently is a C₁-C₁₂ linear or branched alkyl linker group with a terminal amine group (e.g., —NH₂). Illustrative hydroxy-functional polydialklylsiloxanes can be represented by the foregoing structures with hydroxyl groups (—OH) replacing the amino groups (—NH₂). Some examples of functionalized polyslioxanes include functionalized polydimethylsiloxane, functionalized polymethylphenylsiloxane, and functionalized polydiphenylsiloxane.

Some examples of polyperfluoropolyethers with functional group(s) include functionalized poly(n-hexafluoropropylene oxide) (e.g., —(CF₂CF₂CF₂O)n-)NH₂ or —(CF₂CF₂CF₂O)n-)OH for amino or hydroxyl groups) and functionalized poly(hexafluoroisopropylene oxide) (e.g., —(CF(CF₃)CF₂O)nNH₂ or PFPO-NH₂; —(CF(CF₃)CF₂O)nOH or PFPO-OH). Some examples of functionalized atactic polyolefins include functionalized poly(l-butene), branched polyethylene, poly(cis-isoprene), poly(trans-isoprene), and poly (1-octene). Some examples of functionalized polyacrylates include poly(3-functionalized propyl acrylate). Similarly, mono-functional polymers include mono-functional polyisobutylene (e.g., PIB-NH₂; PIB-OH), mono-functional polypolyethylene glycol (e.g., PEG-NH₂, PEG-OH), mono-functional poly(l-butene) (e.g., PB-NH₂, PB-OH, cis and trans) can also be used as the low-glass transition temperature (T g less than 70° C. or 50° C.) polymers, either alone or in combination with other functionalized omniphobic polymers.

The functionalized omniphobic polymers can have any suitable molecular weight in view of desired glass transition temperature, for example having a molecular weight ranging from 300 to 50,000 g/mol. In various embodiments, the molecular weight can be at least 300, 800, 1000, 1500, or 2000 and/or up to 1000, 2000, 3000, 5000, or 50,000 g/mol. The molecular weight can be expressed as a number-average or weight-average value in the units of gram/mole (g/mol). Alternatively or additionally, the functionalized omniphobic polymer can have a number of repeat units ranging from 4 to 600 (e.g., at least 4, 10, 12, 15, 20, or 25 and/or up to 12, 15, 20, 30, 40, 60, 200, or 600; such as a (number) average number of repeat units). Some embodiments can include a blend of two or more amine-functionalized omniphobic polymers with different average molecular weights, such as one with 300-1500 g/mol and another with 1500-50,000 g/mol with a higher average molecular weight than the first. Blends of functionalized omniphobic polymers (e.g., differing in molecular weight and/or in degree of functionality) can improve the combination of water- and oil-repellency properties of the final composition. For example, a mono-functional polysiloxane can provide better water and oil repellency than a di-functional polysiloxane. Low MW functionalized polysiloxanes (e.g., PDMS, such as having a MW range of about 800-1200 g/mol or an average MW of about 1000 g/mol) can provide an improved water repellency, while Higher MW functionalized polysiloxanes (e.g., PDMS, such as about 2000 g/mol or above for an average or range of MW) can provide an improved oil repellency.

The diluent (or solvent) is generally liquid medium that is non-reactive with the monomer components and serves as a solvent for the monomers and corresponding non-gel/non-crosslinked polymers thereof in the concentrate. In embodiments, the diluent (or mixture of multiple diluents) can be present in an amount of 2 wt. % to 60 wt. % relative to the omniphobic composition concentrate, for example in amounts of at least 2, 5, 10, 15, or 20 wt. % and/or up to 20, 25, 30, 35, 40, 50, 55, or 60 wt. %.

In embodiments, the diluent can include one or more of a ketone (or mixtures of ketones), an ester (or mixtures of esters), dimethyl formamide, and dimethyl carbonate. More generally, the omniphobic composition concentrate can include a suitable solvent or diluent, for example an aprotic organic solvent such as acetone, tetrahydrofuran, 2-butanone, other ketones (e.g., methyl n-propyl ketone, methyl isobutyl ketone, methyl ethyl ketone, ethyl n-amyl ketone), esters (e.g., C1-C4 alkyl esters of C1-C4 carboxylic acids, such as methyl, ethyl, n-propyl, butyl esters of acetic acid such as n-butyl acetate, etc., n-butyl propionate, ethyl 3-ethoxy propionate), dimethylformamide, dimethyl carbonate, etc. In some cases, a mixture of two or more solvents or diluents can be used for the concentrate. The solvent or diluent is generally non-reactive and evaporated or otherwise removed when the concentrate is used to form a coating or other cured composition.

In embodiments, the omniphobic composition concentrate is storage stable and remains gel-free for periods of 7 days, 14 days, 28 days, 2 months, 3 months, 4 months, 6 months, or longer, for example after initial formation and reaction to form the concentrate. The concentrate can remain a stable solution without substantial further polymerization during storage that would increase molecular weight or cause crosslinking to create solid/gel precipitate, such as at ambient conditions (e.g., at 10-40° C., 20-30° C., or about 25° C.). A gel-free state can be characterized as a substantial absence of solid or semi-solid materials, for example containing not more than 0.001, 0.01, 0.1, or 1 wt. % of such materials in the concentrate as originally formed or after a given storage period. A gel-free state alternatively can be characterized as the ability to dissolve the concentrate completely in an (excess) amount of common organic solvents (e.g., ketones, esters, and those described above for the diluent). Put another way, a composition that has gelled to some extent would generally contain some higher molecular weight and/or crosslinked polymer components that would precipitate and/or would not be soluble in common organic solvents.

In embodiments, the omniphobic composition concentrate is free from additives and fillers, for example being free or substantially free (e.g., not more than 0.001, 0.01, 0.1, or 1 wt. %) of the various additives and fillers described for the eventual thermoset composition. Typically, any desired additives/fillers would be included in the base formulation to which the concentrate is added to form the thermoset omniphobic composition, but not generally in the concentrate itself.

The omniphobic composition concentrate can be formed by combining the polyisocyanate, the polyol, the functionalized omniphobic polymer, and optionally the diluent in a reaction mixture. The reaction mixture can contain 2 wt. % to 60 wt. % of the polyisocyanate, 30 wt. % to 85 wt. % of the polyol, 10 wt. % to 50 wt. % of the functionalized omniphobic polymer, and up to 60 wt. % of the diluent, for example being present in the various relative amounts and sub-ranges described above for the concentrate. The reaction mixture is then partially reacted to form the polymer including monomer units of the polyisocyanate, the polyol, and the functionalized omniphobic polymer. The reaction to form the concentrate is partial in the sense that at least some unreacted polyol remains in the concentrate composition, but other individual reactants can be partially, completely, or essentially completely reacted, for example such that they are only present in final concentrate as corresponding monomer units in polymerized form. Further, the reaction is limited so that the polymer does not have an excessive molecular weight and/or an excessive degree of crosslinking that would otherwise result in gel (or insoluble) solids formation. Suitable reaction times can be from 5 min to 24 hr, but typically about 1-4 hr or 2-3 hr. Suitable reaction temperatures can be from 20-100° C., for example 20-30° C., 30-40° C., or 40-50° C. In embodiments, a ratio of initial isocyanate groups to a combined amount of initial polyol hydroxy groups and initial functionalized omniphobic polymer reactive groups (e.g., hydroxy and/or amino) is in a range of 1:3 to 1:20. The ratio more generally can be at least 1:2.5, 1:3, 1:4, 1:5, or 1:7 and/or up to 1:4, 1:6, 1:8, 1:10, 1:12, 1:15, 1:20, 1:25, or 1:30, reflecting an excess of initial hydroxy and/or amino groups in the reaction mixture to form the concentrate compared to initial isocyanate groups.

### Thermoset Omniphobic Composition

The omniphobic composition concentrate can be used to form a (thermoset) omniphobic composition by combining the concentrate with a polyurethane base formulation. The concentrate and base formulation can be combined in any suitable manner, for example where all components are combined at once, or where individual base formulation components are combined with the concentrate sequentially, etc. Similarly, the components can be combined by mixing together prior to application of the resulting mixture to a surface or substrate, or by co-applying the concentrate and the base formulation separately or individually to a surface or substrate, etc. The polyurethane base formulation includes at least one further polyisocyanate and at least one further polyol relative to those used to form the omniphobic composition concentrate. The polyurethane base formulation can also include a diluent. Once combined, the omniphobic composition concentrate and the polyurethane base formulation are cured (e.g., on an applied surface) to form a crosslinked reaction product as the (thermoset) omniphobic composition. During curing, the further polyisocyanate and the further polyol can react not only with each other to form a polyurethane structure, but also with the polymer of the concentrate (i.e., which can contain isocyanate, hydroxyl, or other reactive functional groups from the omniphobic polymer) as well as unreacted polyisocyanate, polyol, and/or functionalized omniphobic polymer in the concentrate. The curing step also generally includes evaporation of any solvent or diluent either in the omniphobic composition concentrate or the polyurethane base formulation.

The same general polyisocyanate components as described above can be used for the further polyisocyanate. The further polyisocyanate in the polyurethane base formulation can be the same or different as the polyisocyanate used to form the omniphobic composition concentrate. In some embodiments, the further polyisocyanate includes a tri- or higher-functional isocyanate, for example to promote crosslinking and thermoset formation. In some embodiments, the one or more further polyisocyanates are present in an amount of 5 wt. % to 40 wt. % relative to the polyurethane base formulation (e.g., relative to the combined amount of the further polyisocyanate and the further polyol), for example including at least 5, 10, 15, 20, or 25 wt. % and/or up to 20, 25, 30, 35, or 40 wt. % of further polyisocyanate(s) relative to the polyurethane base formulation.

The same general polyol components as described above can be used for the further polyol. The further polyol in the polyurethane base formulation can be the same or different as the polyol used to form the omniphobic composition concentrate. The same general diluent components as described above can be used in the polyurethane base formulation. In some embodiments, the one or more further polyols are present in an amount of 60 wt. % to 95 wt. % relative to the polyurethane base formulation (e.g., relative to the combined amount of the further polyisocyanate and the further polyol, for example at least 60, 65, 70, 75, or 80 wt. % and/or up to 75, 80, 85, 90, or 95 wt. % of further polyol(s) relative to the polyurethane base formulation.

The diluent in the polyurethane base formulation can be the same or different as the diluent used to form the omniphobic composition concentrate.

In some embodiments, the omniphobic composition concentrate is combined with the polyurethane base formulation (e.g., prior to curing) in a relative amount of 1:10 to 1:100 (w/w) for the omniphobic composition concentrate:the polyurethane base formulation, for example at least 1:10, 1:15, 1:20, 1:25, or 1:30 and/or up to 1:20, 1:25, 1:30, 1:35, 1:40, 1:50, 1:60, 1:80, or 1:100.

In some embodiments, the monomer units of the functionalized omniphobic polymer are present in the (thermoset) omniphobic composition in an amount of 0.2 wt. % to 5 wt. %, for example at least 0.2, 0.4, 0.7, 1, 1.2, or 1.5 wt. % and/or up to 1.5, 2, 2.5, 3, 4, or 5 wt. relative to the (thermoset) omniphobic composition. In some further embodiments, the polyurethane base formulation is free from functionalized omniphobic polymers, such as where the omniphobic composition concentrate is essentially the only source of functionalized omniphobic polymer monomer units in the final crosslinked reaction product and thermoset omniphobic composition.

In some embodiments, the thermoset omniphobic composition can include any suitable organic or inorganic filler or additive, which can be included to improve one or more of mechanical properties, optical properties, electrical properties, and omniphobic properties of the final composition. Suitably, such fillers or additives can be included in the polyurethane base formulation, but are generally not included in the concentrate composition. Examples of suitable fillers or additives include nanoclay, graphene oxide, graphene, silicon dioxide (silica), aluminum oxide, diatomaceous earth, cellulose nanocrystals, carbon nanotubes, titanium dioxide (titania), and combinations or mixtures thereof. In addition, the fillers can include biocides, pigments, dyes, a thermoplastic material, or a combination thereof. The fillers can be added in the range from 0.01 wt. % to 10 wt. %, for example in range from 1 wt. % to 5 wt. %. The foregoing ranges can be relative to the polyurethane base formulation or the thermoset omniphobic composition.

In some embodiments, the omniphobic composition concentrate and the polyurethane base formulation can be applied (e.g., as a mixture or separately) to a substrate. The omniphobic composition concentrate and the polyurethane base formulation can then be cured on the substrate to form the (thermoset) omniphobic composition as a coating on the substrate. Curing, whether performed on the substrate or otherwise, can be performed at a temperature in a range of 25° C. to 120° C. or 45° C. to 70° C. and/or for a time in a range of 1 h to 10 hr or 2 h to 4 hr. The substrate can be any suitable metal, plastic, a thermoplastic, thermoset, glass, wood, fabric (or textile), or ceramic material.

The omniphobic properties of the thermoset composition (e.g., for the cured composition) can be characterized in terms of one or more contact angles and/or sliding angles for water and/or oil droplets (e.g., vegetable oil and/or hexadecane) on the thermoset composition (e.g., as a coating on a substrate). The following ranges are representative of compositions according to the disclosure which display favorable omniphobic properties. In an embodiment, the composition has a water contact angle in a range from 90° to 120° (e.g., at least 90°, 95°, 100°, or 105° and/or up to 110°, 115°, or 120°; such as for the cured composition as a coating). In some cases, the water contact angle can be up to about 125° for non-smooth or rough surfaces. In an embodiment, the composition has an oil contact angle in a range from 0° or 1° to 65° (e.g., at least 1°, 10°, 20°, or 30° and/or up to 40°, 50°, 60°, or 65°; such as for the cured composition as a coating). In an embodiment, the composition has a water sliding angle in a range from 0° or 1° to 30° for a 75 μl droplet (e.g., at least 1°, 2°, 4°, 6°, or 8° and/or up to 10°, 15°, 20°, or 30°; such as for the cured composition as a coating). In an embodiment, the composition has an oil sliding angle in a range from 0° or 1° to 20° for a 25 μl droplet (e.g., at least 1°, 2°, 4°, 6°, or 8° and/or up to 10°, 12°, 15°, or 20°; such as for the cured composition as a coating). The contact angles for the omniphobic coatings can be higher when nanofillers (e.g., clay, silica, etc.) are included in the composition as compared to corresponding compositions without any nanofillers.

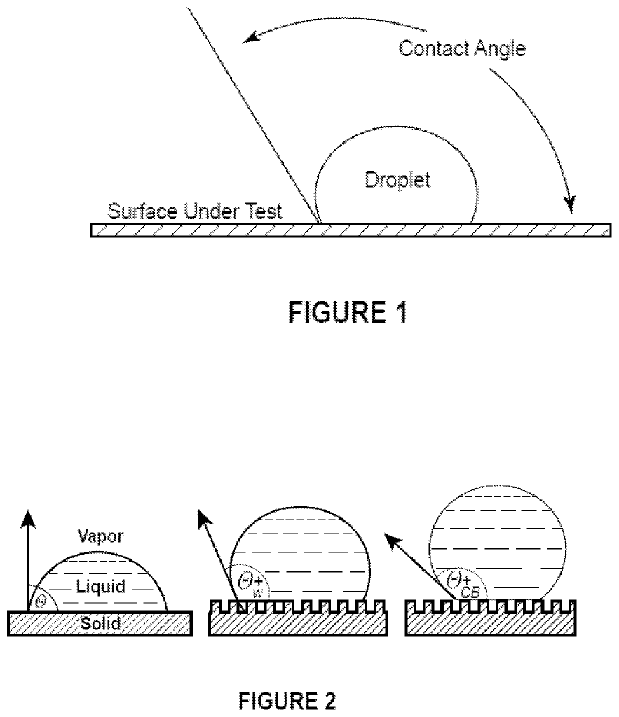

Contact angles (see FIG. 1) are determined by applying a liquid droplet on a test coating surface that is stationary and horizontal with respect to gravity. Any specified liquids can be used, but omniphobic coatings are generally characterized by determining contact angles for water droplets and separately for oil droplets (e.g., a cooking or other common vegetable oil, hexadecane or other oily liquid hydrocarbon). The applied droplets have a volume of about 5 μl (e.g., about 3 μl to 10 μl), although the measured contact angle is not particularly sensitive to actual droplet volume in these ranges. Once applied to the test coating, the droplet can be visually interrogated through any suitable means to determine the contact angle (e.g., using conventional digital image photography and digital image analysis). Suitably, (cured) omniphobic composition coatings according to the disclosure have a water contact angle in a range from 90° to 120° (e.g., at least 90°, 95°, 100°, or 105° and/or up to 110°, 115°, or 120°). Suitably, (cured) omniphobic composition coatings according to the disclosure have an oil contact angle in a range from 0° or 1° to 65° (e.g., at least 1°, 10°, 20°, or 30° and/or up to 40°, 50°, 60°, or 65°).

Sliding angles are determined by applying a liquid droplet on a test coating surface that is initially horizontal with respect to gravity. The test coating surface is then gradually ramped at a controlled/known angle relative to the horizontal plane. Droplets which do not initially spread will remain stationary on the test surface until the test surface is ramped to a sufficiently high angle to cause the droplets to slide down the ramped test surface. The test surface angle at which sliding begins is the sliding angle of the test coating. Any specified liquids can be used, but omniphobic coatings are generally characterized by determining contact angles for water droplets and separately for oil droplets (e.g., a cooking or other common vegetable oil, hexadecane or other oily liquid hydrocarbon). The applied droplets have a specified volume, which is generally about 75 μl (e.g., about 50 μl to 150 μl) for water and about 20 μl (e.g., about 5 μl to 40 μl) for oil. Once applied to the test coating, the droplet can be visually interrogated through any suitable means to determine the sliding angle (e.g., using conventional digital image photography and digital image analysis). Suitably, (cured) omniphobic composition coatings according to the disclosure have a water sliding angle in a range from 0° or 1° to 30° (e.g., at least 1°, 2°, 4°, 6°, or 8° and/or up to 10°, 15°, 20°, or) 30°. Suitably, (cured) omniphobic composition coatings according to the disclosure have an oil contact angle in a range from 0° or 1° to 20° (e.g., at least 1°, 2°, 4°, 6°, or 8° and/or up to 10°, 12°, 15°, or 20°).

The thermoset omniphobic compositions according to the disclosure generally have favorable barrier properties to both polar and non-polar gaseous permeants, for example as represented by favorable barrier properties to both water (polar) and oxygen (non-polar) gaseous permeants. The favorable barrier properties of the thermoset omniphobic compositions according to the disclosure can be characterized in terms of a reduction in permeability for a given gaseous permeant, expressed as the permeability of a thermoset omniphobic composition (e.g., test film) according to the disclosure relative to the permeability of a corresponding thermoset composition (e.g., comparative test film) without the functionalized omniphobic polymer component (e.g., with both compositions/films generally having the same other components, component relative amounts, test film thickness). Suitably, a thermoset omniphobic composition according to the disclosure has a relative permeability for a given gaseous permeant of 0.9, 0.8, 0.7, 0.6, 0.5, 0.4, 0.3, 0.25, 0.2, 0.15, 0.1, 0.05, 0.02, 0.01, or 0.001 or less and/or at least 0.001, 0.01, 0.02, 0.05, 0.1, or 0.15, relative to a corresponding thermoset composition without the functionalized omniphobic polymer. The foregoing ranges can apply independently to individual gaseous permeants (e.g., water and oxygen, with different relative permeability values being characteristic of the film for each or water and oxygen). For example, the thermoset omniphobic composition can have a relative permeability for water vapor of 0.9, 0.7, or 0.3 or less, a relative permeability for oxygen of 0.9, 0.7, 0.3 or less, and/or a relative absorption for water vapor of 0.9, 0.7, or 0.3 or less.

Films are tested for their barrier properties in terms of measured permeability through the film in units of (amountlength)/(areatimepressure), where the amount can be expressed in mass or moles (e.g., equivalently in volume, such as for gases). The barrier properties of a film can be characterized by the permeability of the film with respect to any particular chemical species (e.g., environmental gaseous species), but it is typically characterized with respect to water vapor permeability and oxygen gas permeability. Permeability can be measured using any suitable commercially available instrument for such purpose, for example a MOCON Ox-Tran Model 2/21, MH instrument (for oxygen permeability determination) and a MOCON Model 3/33 instrument (for water permeability determination) (both available from MOCON, Inc., Minneapolis, MN). In a representative procedure, test films are masked to set a reference exposure/transmission test area of 3.14 cm 2 (although other test areas may be suitable, for example for other instrumentation). Permeability is determined through the test film/test area using a controlled, known temperature relative humidity (RH) of the carrier gas as well as the permeant gas. Representative test conditions include 50% RH and approximately room temperature (e.g., 20-25° C., such as 21° C.). The thickness of the test film can be selected to be any desirable value (e.g., corresponding to typical thicknesses of the film in use), for example in a range of about 0.01 μm to 500 μm or 1000 μm (e.g., 10 μm, 100 μm, or 1000 μm test film thickness).

Films can be characterized for their resistance to water transmission based on their absorption or uptake of water vapor under controlled conditions. Test films for the thermoset omniphobic composition and any comparative compositions (e.g., a corresponding thermoset composition without the functionalized omniphobic polymer) are cut into three suitably sized samples, for example 50 mm×50 mm (or 2 in×2 in). The initial weights of the samples are noted. The samples are placed in a humidity chamber at a controlled temperature of 37.5° C. and 85% RH for 24 hours. The samples are then removed from the chamber, weighed, and the weight increase or difference is calculated for all samples to represent water uptake.

In some embodiments, the (thermoset) omniphobic composition is substantially clear or transparent, for example when applied as a coating or thin film on a substrate. For example, the omniphobic composition can have a clarity of at least 90, 95, 98, or 99% and/or up to 94, 96, 98, 99, or 100% transmission, which can represent a fraction or relatively intensity of light (e.g., visible spectrum light) transmitted through the omniphobic composition, such as for a cast film on a glass test slide (e.g., a test film having a thickness in a range of 0.01 μm to 500 μm or 1000 μm, such as about 1 μm, 2 μm, 5 μm, 10 μm, 20 μm, 50 μm, 100 μm, 200 μm, 500 μm, or 1000 μm). In addition, such coated samples can have a very low haze value, such as a haze value not more than 10%, 5%, 3%, or 1% for samples a test film having a thickness in a range of 0.01 μm to 500 μm or 1000 μm, such as about 1 μm, 2 μm, 5 μm, 10 μm, 20 μm, 50 μm, 100 μm, 200 μm, 500 μm, or 1000 μm.

### Coated Article

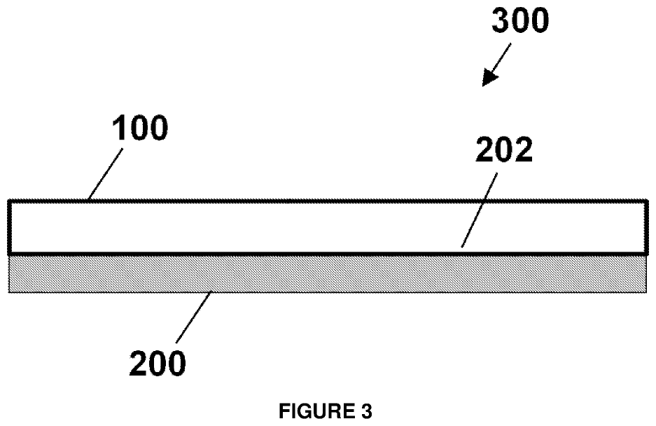

FIG. 3 illustrates an aspect of the disclosure in which a coated article 300 (e.g., desirably having omniphobic properties on at least one surface thereof) includes a substrate 200 and the thermoset omniphobic composition 100 coated on a surface 202 of the substrate 200. The composition 100 can be in the form of a coating or film on an external, environment-facing surface 202 of the substrate 200 (e.g., where the surface 202 would otherwise be exposed to the external environment in the absence of the composition 100). In this case, the thermoset omniphobic composition 100 provides omniphobic protection to the underlying substrate 200.

The substrate 200 is not particularly limited, and generally can be formed from any material desired for protection with an omniphobic coating, in particular given the good, broad adhesive capabilities of the thermoset omniphobic composition 100. For example, the substrate can be a metal, plastic, a different thermoset material (e.g., a primer material; material other than the other than thermoset omniphobic composition), glass, wood, fabric (or textile), or ceramic material. Examples of specific metals include steel, aluminum, copper, etc. Examples of specific plastics include polyvinyl alcohol (PVOH), ethylene vinyl alcohol (EVOH), polyethylene terephthalate (PET), polypropylene (PP), polyethylene (PE), starch, chitosan, etc. Suitable wood materials can be any type of wood commonly used in home, office, and outdoor settings. Suitable glass materials can be those used for building windows, automobile windows, etc. In some embodiments, the substrate 200 is a top layer of a coating or series of coatings on a different underlying substrate. For example, the coated article can include a substrate 200 material as generally disclosed herein, one or more intermediate coatings on the substrate 200 (e.g., an epoxy coating, an acrylic coating, another primer coating, etc.), and the thermoset omniphobic composition 100 on the one or more intermediate coatings as the final, external coating on the coated article 300.

The thermoset omniphobic composition 100 can have any desired thickness on the substrate 200. In common applications, the composition 100 has a thickness ranging from 0.010 μm to 500 μm, for example at least 0.01, 10, 20, 50, or 100 μm and/or up to 200, 500 μm. Typical cast coatings can have thicknesses of 10 μm to 100 μm. Typical spin coatings can have thicknesses of 0.05 μm or 0.10 μm to 0.20 μm or 0.50 μm. Multiple coating layers can be applied to substrate 200 to form even thicker layers of the composition 100 (e.g., above 500 μm or otherwise) if desired.

### EXAMPLES

The following examples illustrate the disclosed compositions and methods, but are not intended to limit the scope of any claims thereto. In the following examples, omniphobic composition concentrates generally according to the disclosure are prepared and then cured with a polyurethane base formulation to form a film or coating on a test substrate such as glass.

### Example 1

An omniphobic composition concentrate was formed by dissolving acrylic polyol (2 g), a multifunctional isocyanate (25 mg), and a difunctional isocyanate (1.3 gram) in a mixture of ketone/ester solvents (2 ml). To the above solution, a mixture of hydroxy-functionalized polydimethyl siloxane (PDMS-OH; 2 g) and acrylic polyol made of more than one type of monomers with at least one monomer having a free hydroxyl group (4.5 g), diluted with ketone/ester solvents (1 ml) were added and stirred for 24 hours. The final concentrate included about 20 wt. % PDMS units in a polymer containing monomer units of the polyisocyanates, the polyol, and the functionalized omniphobic polymer. The final concentrate was gel-free and clear, remaining so for many days.

A coating was formed using the omniphobic composition concentrate by taking 0.25 ml of the concentrate and mixing with a polyurethane base formulation including 5 ml polyol HPC-15 and 1.0 ml of multifunctional isocyanate. A portion of the resulting mixture of concentrate and base formulation (0.8 mL) was cast on a glass slide and cured at 60° C. overnight and then evaluated for transparency, anti-ink properties, oil repellency, and water repellency. The film had a transparency/light transmission of about 99% (where 100% is observed for a blank glass slide), and excellent anti-ink properties, oil repellency, and water repellency.

### Example 2

An omniphobic composition concentrate was formed by dissolving acrylic polyol (2 g) and a difunctional isocyanate (1.3 gram) in a mixture of ketone/ester solvents (2 ml). To the above solution, a mixture of hydroxy-functionalized polydimethyl siloxane (PDMS-OH; 2 g) and acrylic polyol (4.5 g), diluted with ketone/ester solvents (1 ml) were added and stirred for 24 hours. The final concentrate included about 20 wt. % PDMS units in a polymer containing monomer units of the polyisocyanate, the polyol, and the functionalized omniphobic polymer. The final concentrate was gel-free and clear, remaining so for many days.

A coating was formed using the omniphobic composition concentrate by taking 0.25 ml of the concentrate and mixing with a polyurethane base formulation including 5 ml polyol HPC-15 and 1.0 ml of multifunctional isocyanate. A portion of the resulting mixture of concentrate and base formulation (0.8 mL) was cast on a glass slide and cured at 60° C. overnight and then evaluated for transparency, anti-ink properties, oil repellency, and water repellency. The film had a transparency/light transmission of about 99% (where 100% is observed for a blank glass slide), and excellent anti-ink properties, oil repellency, and water repellency.

### Example 3

An omniphobic composition concentrate was formed by combining PDMS-OH (1 g) dissolved in 1 ml ketone/ester solvent mixture, and difunctional isocyanate (200 mg). This mixture was stirred for 6-8 hours. Then, 2 g acrylic polyol was added, followed by stirring for 24 hours. The final concentrate included about 30 wt. % PDMS units in a polymer containing monomer units of the polyisocyanate, the polyol, and the functionalized omniphobic polymer. The final concentrate was gel-free and clear, remaining so for many days.

Coatings were formed using the omniphobic composition concentrate by taking 0.25 ml of the concentrate and mixing with 5 ml polyol HPC-15, which was then stirred for 10-15 minutes. Next, 1.0 ml of multifunctional isocyanate was added to the reaction mixture and stirred for 10, 20, or 30 minutes. A portion of the resulting mixture of concentrate and base formulation components (0.8 mL) was cast on a glass slide and cured at 60° C. overnight and then evaluated for transparency, anti-ink properties, oil repellency, and water repellency. The film had a transparency/light transmission of about 99% (where 100% is observed for a blank glass slide), and excellent anti-ink properties, oil repellency, and water repellency.

Coatings were also formed using the omniphobic composition concentrate by taking 0.25 ml of the concentrate and mixing with 1 ml multifunctional isocyanate and 0.5 mL ester/ketone solvent mixture followed by stirring for 10-15 minutes. Next 5.0 ml acrylic polyol was added to the reaction mixture and stirred for 10, 20, or 30 minutes. A portion of the resulting mixture of concentrate and base formulation components (0.8 mL) was cast on a glass slide and cured at 60° C. overnight and then evaluated for transparency, anti-ink properties, oil repellency, and water repellency. The film had a transparency/light transmission of about 99% (where 100% is observed for a blank glass slide), and excellent anti-ink properties, oil repellency, and water repellency.

This example illustrates that the base formulation components can be added separately and in any order to the omniphobic composition concentrate while still forming a high-clarity and resistant thermoset omniphobic composition coating.

### Example 4

An omniphobic composition concentrate was formed by dissolving acrylic polyol (4 ml) and an amine-functionalized polydimethyl siloxane (PDMS-amine; 1 g) in a 20 mL vial. A multifunctional isocyanate (200 mg dissolved in 1 mL ester/ketone) was added to the above solution at a rate of 0.2 mL every 10 minutes. This reaction mixture was stirred for 24 hours. The final concentrate included about 20 wt. % PDMS units in a polymer containing monomer units of the polyisocyanate, the polyol, and the functionalized omniphobic polymer. The final concentrate was gel-free and had a clear yellow color, remaining so for many days.

Coatings were formed using the omniphobic composition concentrate by taking 0.25 ml of the concentrate and mixing with 5 ml polyol HPC-15, which was then stirred for 10-15 minutes. Next, 1.0 ml of multifunctional isocyanate was added to the reaction mixture and stirred for 10, 20, or 30 minutes. A portion of the resulting mixture of concentrate and base formulation components (0.8 mL) was cast on a glass slide and cured at 60° C. overnight and then evaluated for transparency, anti-ink properties, oil repellency, and water repellency. The film had a transparency/light transmission of about 99% (where 100% is observed for a blank glass slide), and excellent anti-ink properties, oil repellency, and water repellency.

### Example 5

The omniphobic composition concentrates from Examples 1-4 were used to form coatings by combining the concentrate with a polyol from Covestro (MULTRANOL 4012 or MULTRANOL E434) and a multifunctional isocyanate (UH80) as the base formulation. All of the coatings had a PDMS level of about 1 wt. % and had formed a clear coating with a clarity/transmission of at least 97%, with the exception of the combination of Example 4, MULTRANOL E434, and UH80 (which formed a slightly hazy, non-homogeneous coating).

Because other modifications and changes varied to fit particular operating requirements and environments will be apparent to those skilled in the art, the disclosure is not considered limited to the example chosen for purposes of illustration, and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In case of conflict, the present description, including definitions, will control.

Throughout the specification, where the compositions, processes, kits, or apparatus are described as including components, steps, or materials, it is contemplated that the compositions, processes, or apparatus can also comprise, consist essentially of, or consist of, any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

What is claimed is:

1. An omniphobic composition concentrate comprising:
2 wt. % to 60 wt. % relative to the omniphobic composition concentrate of at least one of a polyisocyanate and monomer units thereof in polymerized form;
30 wt. % to 85 wt. % relative to the omniphobic composition concentrate of at least one of a polyol and monomer units thereof in polymerized form;
10 wt. % to 50 wt. % relative to the omniphobic composition concentrate of at least one of a functionalized omniphobic polymer and monomer units thereof in polymerized form; and
optionally up to 60 wt. % relative to the omniphobic composition concentrate of at least one diluent;
wherein:
the omniphobic composition comprises the polyol;
the omniphobic composition comprises a polymer comprising monomer units of the polyisocyanate, monomer units of the polyol, and monomer units of the functionalized omniphobic polymer; and
the omniphobic composition is in the form of a gel-free liquid.

2. The omniphobic composition concentrate of claim 1, wherein the omniphobic composition concentrate comprises the at least one diluent in an amount of 2 wt. % to 60 wt. % relative to the omniphobic composition concentrate.

3. The omniphobic composition concentrate of claim 2, wherein the diluent comprises one or more of a ketone, an ester, dimethyl formamide, and dimethyl carbonate.

4. The omniphobic composition concentrate of claim 1, wherein:
the at least one of the polyisocyanate and the monomer units thereof in polymerized form are present in an amount of 3 wt. % to 60 wt. % relative to a combined amount of the polyisocyanate, the monomer units thereof in polymerized form, the polyol, the monomer units thereof in polymerized form, the functionalized omniphobic polymer, and the monomer units thereof in polymerized form;
the at least one of the polyol and the monomer units thereof in polymerized form are present in an amount of 30 wt. % to 90 wt. % relative to a combined amount of the polyisocyanate, the monomer units thereof in polymerized form, the polyol, the monomer units thereof in polymerized form, the functionalized omniphobic polymer, and the monomer units thereof in polymerized form; and
the at least one of the functionalized omniphobic polymer and the monomer units thereof in polymerized form are present in an amount of 10 wt. % to 50 wt. % relative to a combined amount of the polyisocyanate, the monomer units thereof in polymerized form, the polyol, the monomer units thereof in polymerized form, the functionalized omniphobic polymer, and the monomer units thereof in polymerized form.

5. The omniphobic composition concentrate of claim 1, wherein a ratio of reacted isocyanate groups to a combined amount of free polyol hydroxy groups and free functionalized omniphobic polymer reactive groups is in a range of 1:2 to 1:20.

6. The omniphobic composition concentrate of claim 1, wherein the omniphobic composition concentrate is substantially free from isocyanate groups.

7. The omniphobic composition concentrate of claim 1, wherein the omniphobic composition concentrate contains the polyol in an amount of 40 wt. % to 90 wt. % relative to a combined amount of the polyol and the monomer units thereof in polymerized form.

8. The omniphobic composition concentrate of claim 1, wherein the omniphobic composition concentrate contains the functionalized omniphobic polymer in an amount up to 50 wt. % relative to a combined amount of the functionalized omniphobic polymer and the monomer units thereof in polymerized form.

9. The omniphobic composition concentrate of claim 1, wherein the omniphobic composition concentrate remains gel-free for a period of 7 days.

10. The omniphobic composition concentrate of claim 1, wherein the omniphobic composition concentrate is free from additives and fillers.

11. The omniphobic composition concentrate of claim 1, wherein the polyisocyanate comprises a diisocyanate.

12. The omniphobic composition concentrate of claim 1, wherein the polyisocyanate comprises a triisocyanate.

13. The omniphobic composition concentrate of claim 1, wherein the polyisocyanate is selected from the group consisting of 1,5-naphthylene diisocyanate, 4,4′-diphenylmethane diisocyanate (MDI), hydrogenated MDI, xylene diisocyanate (XDI), tetramethylxylol diisocyanate (TMXDI), 4,4′-diphenyl-dimethylmethane diisocyanate, di- and tetraalkyl-diphenylmethane diisocyanate, 4,4′-dibenzyl diiso-cyanate, 1,3-phenylene diisocyanate, 1,4-phenylene diisocyanate, one or more isomers of tolylene diisocyanate (TDI), 1-methyl-2,4-diiso-cyanatocyclohexane, 1,6-diisocyanato-2,2,4-trimethyl-hexane, 1,6-diisocyanato-2,4,4-trimethylhexane, 1-iso-cyanatomethyl-3-isocyanato-1,5,5-trimethylcyclohexane, chlorinated and brominated diisocyanates, phosphorus-containing diisocyanates, 4,4′-diisocyanatophenyl-perfluoroethane, tetramethoxybutane 1,4-diisocyanate, butane 1,4-diisocyanate, hexane 1,6-diisocyanate (HDI), HDI dimer (HDID), HDI trimer (HDIT), HDI biuret, dicyclohexylmethane diisocyanate, cyclohexane 1,4-diisocyanate, ethylene diisocyanate, phthalic acid bisisocyanatoethyl ester, 1-chloromethylphenyl 2,4-diisocyanate, 1-bromomethylphenyl 2,6-diisocyanate, 3,3-bischloromethyl ether 4,4′-diphenyldiisocyanate, trimethylhexamethylene diisocyanate, 1,4-diisocyanato-butane, 1,2-diisocyanatododecane, and combinations thereof.

14. The omniphobic composition concentrate of claim 1, wherein the polyol comprises a diol.

15. The omniphobic composition concentrate of claim 1, wherein the polyol comprises three or more hydroxyl groups.

16. The omniphobic composition concentrate of claim 1, wherein the polyol is selected from the group consisting of polyether polyols, hydroxylated (meth)acrylate oligomers, glycerol, ethylene glycol, diethylene glycol, triethylene glycol, tetraethylene glycol, propylene glycol, dipropylene glycol, tripropylene glycol, 1,3-propanediol, 1,3-butanediol, 1,4-butanediol, neopentyl glycol, 1,6-hexanediol, 1,4-cyclohexanedimethanol, glycerol, trimethylolpropane, 1,2,6-hexanetriol, pentaerythritol, (meth)acrylic polyols, polyester polyols, polyurethane polyols, and combinations thereof.

17. The omniphobic composition concentrate of claim 1, wherein the functionalized omniphobic polymer comprises a dihydroxy-functional polysiloxane.

18. The omniphobic composition concentrate of claim 1, wherein the functionalized omniphobic polymer comprises a diamino-functional polysiloxane.

19. The omniphobic composition concentrate of claim 1, wherein the functional group of the functionalized omniphobic polymer is selected from the group consisting of amino groups, hydroxyl groups, and combinations thereof.

20. The omniphobic composition concentrate of claim 1, wherein the functionalized omniphobic polymer is selected from the group consisting of functionalized polysiloxanes, functionalized polyperfluoroethers, functionalized polybutadienes, functionalized polyisobutenes, functionalized branched polyolefins, functionalized low molecular weight polyolefins, functionalized poly(meth)acrylates, and combinations thereof.

21. The omniphobic composition concentrate of claim 1, wherein the functionalized omniphobic polymer comprises a mono-functional functionalized omniphobic polymer.

22. The omniphobic composition concentrate of claim 1, wherein the functionalized omniphobic polymer comprises a di-functional functionalized omniphobic polymer.

23. The omniphobic composition concentrate of claim 1, wherein the functionalized omniphobic polymer comprises a poly-functional functionalized omniphobic polymer.

24. The omniphobic composition concentrate of claim 1, wherein the functionalized omniphobic polymer has a glass transition temperature in a range from −150° C. to 70° C.

25. The omniphobic composition concentrate of claim 1, wherein the functionalized omniphobic polymer is a liquid at a temperature in a range from 10° C. to 40° C.

26. The omniphobic composition concentrate of claim 1, wherein the functionalized omniphobic polymer has a molecular weight ranging from 300 to 50,000.

27. A method for forming an omniphobic composition concentrate, the method comprising:
providing a reaction mixture comprising:
2 wt. % to 60 wt. % relative to the reaction mixture of at least one polyisocyanate;
30 wt. % to 85 wt. % relative to the reaction mixture of at least one polyol;
10 wt. % to 50 wt. % relative to the reaction mixture of at least one functionalized omniphobic polymer; and
optionally up to 60 wt. % relative to the reaction mixture of at least one diluent;
partially reacting the at least one polyisocyanate, the at least one polyisocyanate, and the at least one functionalized omniphobic polymer to form a polymer comprising monomer units of the polyisocyanate, monomer units of the polyol, and monomer units of the functionalized omniphobic polymer, thereby forming the omniphobic composition concentrate of claim 1.

28. A method for forming a thermoset omniphobic composition, the method comprising:
combining (i) the omniphobic composition concentrate of claim 1, and (ii) a polyurethane base formulation comprising at least one further polyisocyanate and at least one further polyol; and
curing the omniphobic composition concentrate and the polyurethane base formulation to form a crosslinked reaction product as the thermoset omniphobic composition.

29. The method of claim 28, wherein the omniphobic composition concentrate is combined with the polyurethane base formulation in a relative amount of 1:10 to 1:100 (w/w) for the omniphobic composition concentrate:the polyurethane base formulation.

30. The method of claim 28, wherein the monomer units of the functionalized omniphobic polymer are present in the thermoset omniphobic composition in an amount of 0.2 wt. % to 5 wt. % relative to the thermoset omniphobic composition.

31. The method of claim 28, wherein the at least one further polyisocyanate comprises a tri- or higher-functional isocyanate.

32. The method of claim 28, wherein:
the at least one further polyisocyanate is present in an amount of 5 wt. % to 40 wt. % relative to the polyurethane base formulation; and
the at least one further polyol is present in an amount of 60 wt. % to 95 wt. % relative to the polyurethane base formulation.

33. The method of claim 28, wherein the polyurethane base formulation is free from functionalized omniphobic polymers.

34. The method of claim 28, wherein the polyurethane base formulation further comprises one or more additives (or fillers) selected from the group consisting of nanoclay, graphene oxide, graphene, silicon dioxide (silica), aluminum oxide, cellulose nanocrystals, carbon nanotubes, titanium dioxide (titania), diatomaceous earth, biocides, pigments, dyes, thermoplastics, and combinations thereof.

35. The method of claim 28, comprising performing curing at a temperature in a range of 25° C. to 120° C. and for a time in a range of 1 h to 10 hr.

36. The method of claim 28, further comprising:
applying the omniphobic composition concentrate and the polyurethane base formulation to a substrate; and
curing the omniphobic composition concentrate and the polyurethane base formulation on the substrate, thereby forming the thermoset omniphobic composition as a coating on the substrate.

37. The method of claim 36, the substrate is selected from the group of metal, plastics, a different thermoset material, glass, wood, fabric (or textile), and ceramics.

38. The method of claim 28, wherein the thermoset omniphobic composition has a water contact angle in a range from 90° to 120°.

39. The method of claim 28, wherein the thermoset omniphobic composition has an oil contact angle in a range from 1° to 65°.

40. The method of claim 28, wherein the thermoset omniphobic composition has a water sliding angle in a range from 1° to 30° for a 75 μl droplet.

41. The method of claim 28, wherein the thermoset omniphobic composition has an oil sliding angle in a range from 1° to 20° for a 10 μl droplet.

42. The method of claim 28, wherein the thermoset omniphobic composition has a thickness ranging from 0.01 μm to 500 μm.

43. The method of claim 28, wherein the thermoset omniphobic composition has a clarity of at least 90% transmission.

44. A coated article comprising:
(a) a substrate; and
(b) a thermoset omniphobic composition formed according to claim 36, coated on a surface of the substrate.
